(19) United States
(12) Patent Application Publication
(10) Pub. No.: US 2025/0107534 A1
(43) Pub. Date: Apr. 3, 2025

(54) Device for Twisting Dough Pieces

(71) Applicant: Radie B.V., Culemborg (NL)

(72) Inventor: Johannes Josephus Antonius Van Blokland, Culemborg (NL)

(21) Appl. No.: 18/897,293

(22) Filed: Sep. 26, 2024

(30) Foreign Application Priority Data
Sep. 28, 2023 (NL) 2035912

(51) Int. Cl. A21C 3/08; A21C 9/08

(52) U.S. Cl. CPC A21C 3/08; A21C 9/08

(57) ABSTRACT

Device for twisting dough pieces, comprising a pair of conveyor belts, comprising a first and a second conveyor belt, with mutually facing conveying surfaces for clamping a dough piece between them, and for transporting the dough piece in the conveying direction of the mutually facing conveying surfaces of the first and a second conveyor belt, which transport direction is the longitudinal direction of said dough piece, a third conveyor belt, positioned downstream of the pair of conveyor belts in the conveying direction, for taking over a dough piece from the pair of conveyor belts and transporting it further in the longitudinal direction thereof, wherein the pair of conveyor belts is rotatable around a rotation axis extending in the longitudinal direction, for twisting the dough piece around the longitudinal axis during the transfer of the dough piece from the pair of conveyor belts to the third conveyor belt.

The present invention relates to a device for twisting dough pieces, in particular twisting unbaked dough pieces over a twisting axis that extends in their length direction. The invention also relates to such device, for forming part of a continuous dough handling line, wherein dough pieces are formed from a continuous dough sheet, and may be processed in a continuous way after being twisted.

Various dough products exist that are formed by a twisted dough piece. At an industrial scale, this twisting is always a difficult step in dough handling. For this processing step, the dough has to be gripped, twisted and released, and these steps have to be performed on subsequent dough pieces, preferably at high speeds.

However, gripping and releasing dough are handling steps that are sensitive to errors, and the handling devices are sensitive for contamination due to the touching and releasing of the dough, that may stick to the gripping surfaces of such device.

As an addition, the elasticity of the dough makes the twisting a challenging task, apart from the technical difficulties described above.

It is therefore a goal of the present invention to provide a device that overcomes the above mentioned disadvantages.

The invention thereto proposes a device for twisting dough pieces, comprising:
a pair of conveyor belts, comprising a first and a second conveyor belt, with mutually facing conveying surfaces for clamping a dough piece between them, and for transporting the dough piece in the conveying direction of the mutually facing conveying surfaces of the first and a second conveyor belt, which transport is the longitudinal direction of said dough piece;
a third conveyor belt, positioned downstream of the pair of conveyor belts in the conveying direction, for taking over a dough piece from the pair of conveyor belts and transporting it further in the longitudinal direction thereof;
   wherein
the pair of conveyor belts is rotatable around a rotation axis extending in the longitudinal direction, for twisting the dough piece around the longitudinal axis during the transfer of the dough piece from the pair of conveyor belts to the third conveyor belt.

The conveyor belts in the device according to the invention may be endless conveyor belts. These conveyor belts form the part of the device that engages the dough pieces to be twisted while twisting. As the belts are looped around rollers, they gradually unwind the dough, which is then peeled off without sticking to the conveyor belt surface.

The belts may be pre-tensioned toward each other, and/or be positioned at a mutual distance that exactly matches the thickness of dough pieces to be twisted, so that during twisting, the dough cannot slide between the pair of conveyor belts, or fall out of it. Additionally, and/or alternatively, the conveyor belt surfaces of the pair of conveyor belts, may be profiled, such as ribbed or provided with similar grip enhancing means. The distance and/or tension between the conveyor belts forming the pair of belts may be adjustable.

In use, a dough piece may be placed between the conveyor belts of the pair of belts, conveyed until its leading edge reaches the downstream end of the pair of conveyor belts. From that point on, the leading edge may be further conveyed, so that it is partly supported by the third conveyor belt. Once this stage is reached, the pair of conveyor belts may be driven to rotate with respect to the third conveyor belt, therewith twisting the dough piece at the point where it is taken over from the pair of conveyor belts to the third conveyor belt.

The device according to the invention has the advantage of allowing also soft doughs with a high water content to be twisted, whether or not combined with a pre-fermentation process. In practice, such dough is very elastic and possibly sticky and is even difficult to twist manually.

The device according to the invention may comprise a fourth conveyor belt, positioned upstream in the transport direction with respect to the pair of conveyor belts, for delivering, in the transport direction, a piece of dough to be twisted around its longitudinal axis to the pair of conveyor belts. This fourth conveyor belt then serves to deliver the dough pieces to be twisted to the pair of conveyor belts.

The third and/or fourth conveyor belt may be arranged such that they convey dough pieces at a support level that matches the position the dough pieces may have in between the pair of conveyor belts. This allows for a flush transfer of dough pieces and has proven to allow the creation of stable dough pieces on the fourth conveyor belt.

In a preferred embodiment of a device according to the invention, the pair of conveyor belts is suspended in a frame that is rotatable with respect to the third conveyor belt. Such frame may comprise drive means for driving the pair of conveyor belts and for rotating the frame itself.

Preferably however, in order to avoid the need of leading wiring or other drive means to rotating parts of the frame, the frame may be provided on an outwardly facing side with a first force or torque transmission system, such as a gear ring or a pulley for a belt, for transmitting a driving force or torque for the rotation of the frame from an external drive located outside the frame, to the frame. This allows a drive system to be externally arranged and to be provided with engaging means for the force or torque transmission system, such as a gear wheel or a belt. This construction allows to mount driving means below the level where food products are handled and facilitates easy maintenance and a relatively simple and robust construction.

The frame may additionally be provided on an outwardly projecting with a second force or torque transmission system, such as a gear ring or a pulley for a belt, for transmitting a driving force or torque for the movement of the pair of conveyor belts for transporting the dough piece in the conveying direction. Both force or torque transmission systems may be independently accessible, in order to allow independent control of the rotational movement of the pair of conveyor belts and the driving of the pair of conveyor belts for transporting the dough piece in the conveying direction. Accordingly, the device may be provided with an independently controllable first and a second external drive, each engaging one of the transmission systems.

The device according to the invention may further comprise a control system, arranged for controlling the first and second external drive, but more in particular arranged for discounting the mutual influence of a driving force or torque for the rotation of the frame and a driving force or torque for the movement of the pair of conveyor belts. This mutual influence may be caused by the fact that both the driving force or torque for the rotation of the frame and a driving force or torque for the movement of the pair of conveyor belts are transferred to the frame by a rotational movement of the frame or a transmission or part thereof coupled to the frame. When for instance the driving force or torque for the movement of the pair of conveyor belts is transferred to the frame via a gear ring and gear wheels coupled therewith, such gear ging is also rotated when the frame is driven in order to rotate. Such rotation should then be taken into account when providing the driving force or torque for the movement of the pair of conveyor belts, and be compensated for.

The fourth conveyor belt may be arranged to move continuously, and/or to continuously supply dough pieces to the conveyor belt. In general, all four belts may be configured and/or controlled to have the same speed of conveyance, although the third conveyor belt may also be configured to have a lower speed, when the dough pieces become shorter during twisting, or a higher speed, when the dough pieces are (to be) stretched.

In yet another embodiment, the device according to the invention comprises a portioning device for supplying dough pieces to the fourth conveyor, designed for supplying dough pieces to the pair of conveyor belts with a mutual distance in the transport direction that is at least equal to the length of a dough piece. Preferably, the dough pieces all have the same, fixed length and a fixed mutual distance. The portioning device may be adapted for supplying dough pieces with such a mutual distance that a number of N dough pieces together with N−1 mutual distances has a maximum length of the distance of the transport surfaces of the pair of conveyor belts facing each other. This results in no new dough piece arriving from the fourth conveyor belt during twisting of a dough piece. There may be one or more other dough pieces between the pair of conveyor belt when one dough piece is being twisted. Those dough pieces are only flipped several times at that moment.

In yet another embodiment, the device comprises a clamp for fixing the position of a downstream end of a dough piece with respect to the third conveyor, to prevent the dough piece from rotating during twisting. Such clamp may be designed to move with the dough piece during twisting, and after twisting the dough piece to move back to a position for clamping a next dough piece.

The invention will now be elucidated into more detail with reference to the following figures. Herein:

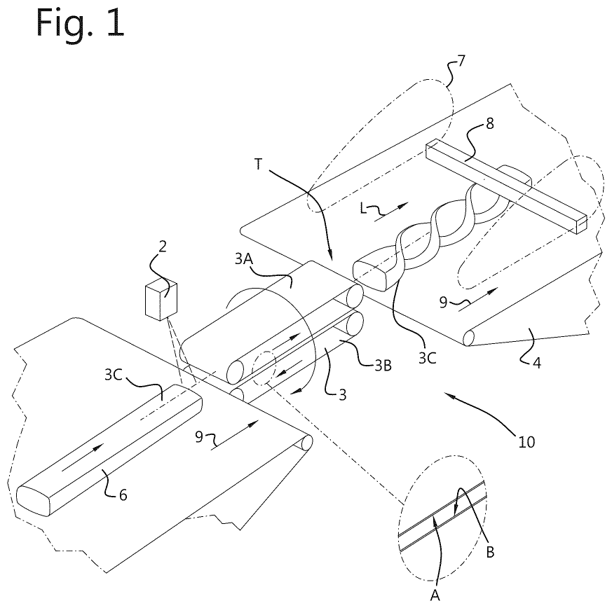

FIG. 1 shows a simplified perspective overview of a device according to the invention;

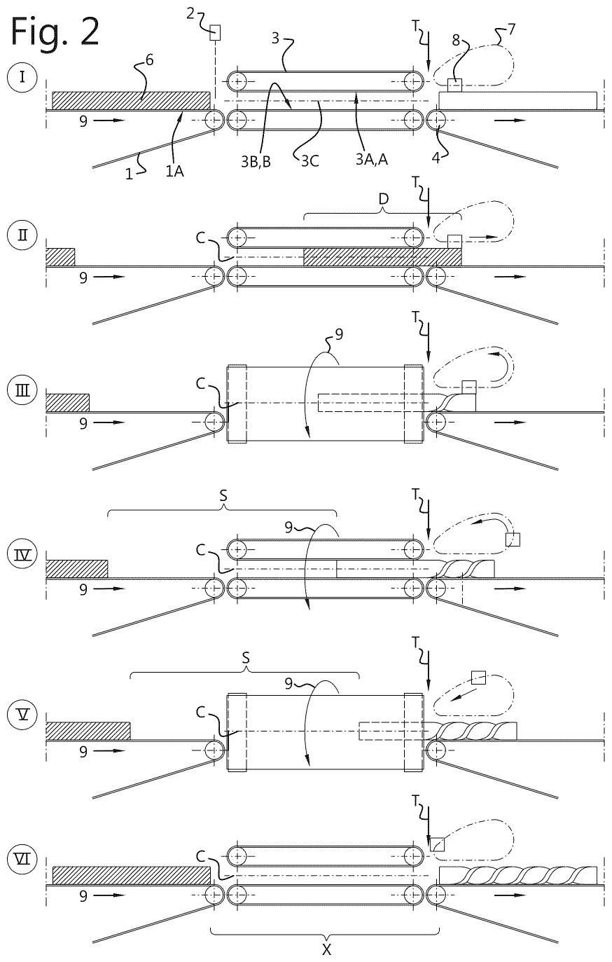

FIG. 2 shows a number of steps during a first use of the device from FIG. 1;

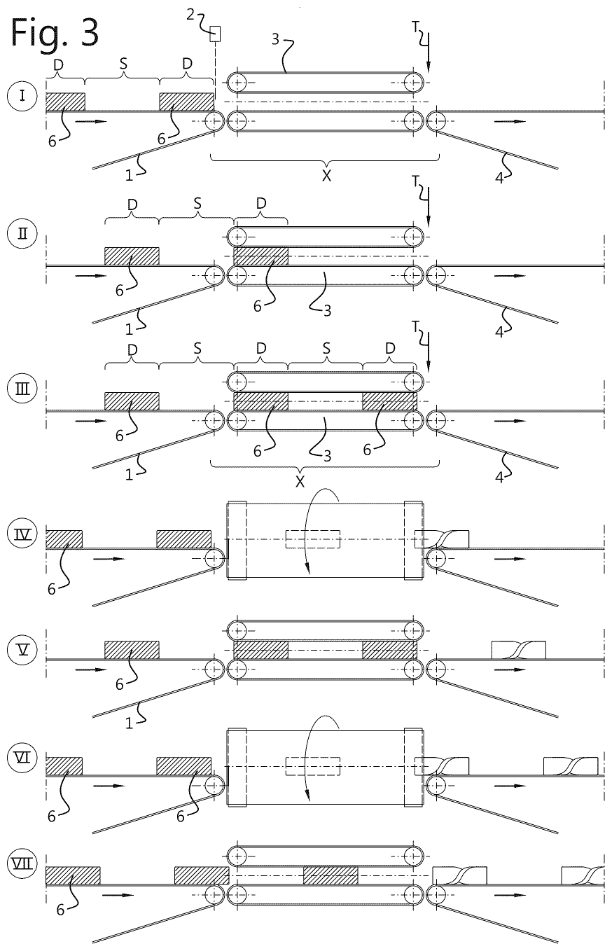

FIG. 3 shows a number of steps during a second use of the device from FIG. 1;

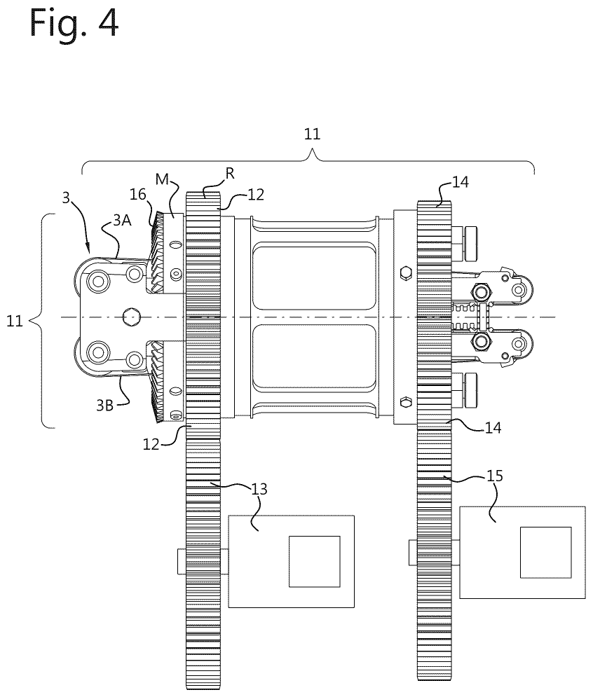

FIG. 4 shows a detailed technical implementation of part of the device from FIG. 1;

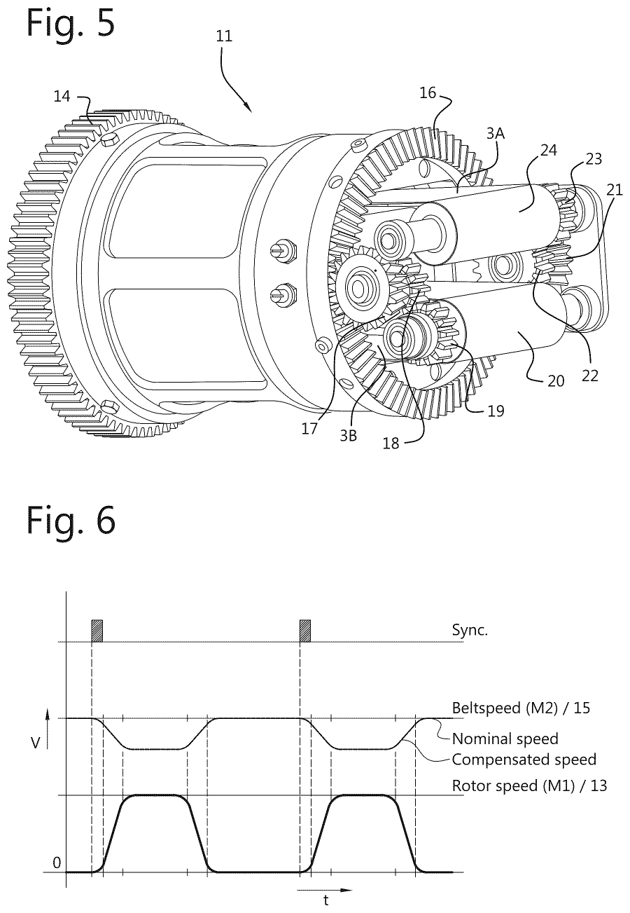

FIG. 5 shows a detailed perspective view of the device from FIG. 1;

FIG. 6 shows a graph with control characteristics for controlling the device from FIG. 1; and

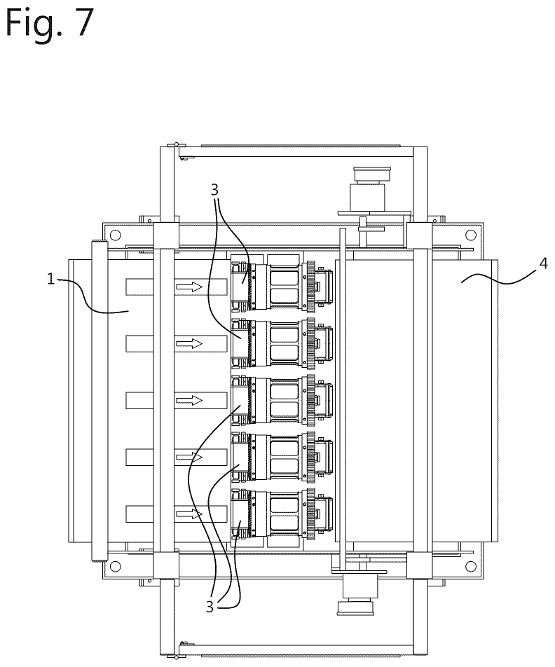

FIG. 7 shows an arrangement of multiple devices according to the invention.

FIG. 1 shows a device 10 for twisting dough pieces 6, comprising a pair 3 of conveyor belts, comprising a first and a second conveyor belt 3A, 3B, with mutually facing conveying surfaces for clamping a dough piece 6 between them, and for transporting the dough piece 6 in the conveying direction 9 of the mutually facing conveying surfaces A, B of the first and a second conveyor belt 3A, 3B, which transport direction is the longitudinal direction L of said dough pieces 6. The device further comprises a third conveyor belt 4, positioned downstream of the pair 3 of conveyor belts in the conveying direction 9, for taking over a dough piece 6 from the pair 3 of conveyor belts and transporting it further in the longitudinal direction L thereof, being parallel to the conveying direction 9 in the example shown. The pair 3 of conveyor belts is rotatable around a rotation axis 3C extending in the longitudinal direction 9, for twisting the dough pieces 6 around the longitudinal axis L during the transfer of the dough piece 6 from the pair 3 of conveyor belts to the third conveyor belt 4. This transfer and twisting take place at location T in FIG. 1. The rotation of the pair of conveyors 3 is triggered by a signal obtained from sensor 2, that detects a leading edge from a dough piece 3. Based on known speeds and lengths of the fourth conveyor 1 and the dough piece 6, the twisting may be controlled.

FIG. 2 shows steps I-VI, taking place subsequently when using the device according to the invention. During a first step I, the fourth conveyor belt 1 delivers a dough piece 6 in the direction of conveyance 9, toward the pair 3 of conveyor belts. Said pair of conveyor belts is in a receiving position and orientation for receiving a dough piece 6. That means, its surface B is aligned with surface of the fourth conveyor belt 1 for a smooth transition. Clamp 7 is in a resting position above the third conveyor 4.

During step II the dough piece 6 is moved in between the pair of conveyors 3, and in this example, a leading end is already on the third conveyor 4, and clamped by clamp 7, that has travelled along in the direction of conveyance 9 from the moment it engaged the dough piece 6.

During steps III-IV-V the pair 3 of conveyor belts rotates around its axis C and the dough piece 6 is twisted. In general, the pair of conveyor belts 3 and the third conveyor belt 4 and the fourth conveyor belt 1 have the same speed in the direction of conveyance 9. The turning speed relative to the speed of the conveyance of the pair of conveyor belts 3 determines the amount of twists, or in other words, the number of turns made by the pair of conveyor belts during conveyance of the dough piece 6 from the pair of conveyor belts 3 to the third conveyor belt 4. It is visible that during step IV, the clamp 7 disengages the dough piece 6, which then has enough resistance to remain on the third conveyor belt 4 without rolling around its longitudinal axis L. It is however thinkable in general with respect to the present invention that the third conveyor belt has a different, in particular lower, speed than the pair of conveyor belts 3.

In step VI the first dough piece 6 has left the pair 3 of rotating conveyor belts, and a next dough piece 6 is ready to enter the pair 3 of conveyor belts. The device is dimensioned such, that the length X of the pair 3 of conveyor belts is at least the length D of a certain number N of dough pieces 6, plus N−1 lengths of the spaces S between the dough pieces 6. In this case, N equals 1.

FIG. 3 shows similar steps to those from FIG. 2, be it that a situation is depicted wherein the number N is 2. It is visible that during steps I-III, two dough pieces 6 are brought in between the pair 3 of conveyor belts. During step IV, the leading dough piece is twisted, while the lagging dough piece is only flipped a number of times.

Step V shows that a next dough piece 6 has entered the pair 3 of conveyor belts, before the former lagging dough piece 6, now leading, can be twisted. Steps III-V are then repeated as long as new dough pieces 6 are delivered by the fourth conveyor belt 1.

FIG. 4 shows a technical implementation of the pair 3 of conveyor belts of the device from FIGS. 1-3. The pair of conveyor belts is arranged in a rotatable frame 11, which is provided on an outwardly facing side with a first force or torque transmission system 12, formed by a gear ring, for transmitting a driving force or torque for the rotation of the frame from an external drive 13 located outside the frame, to the frame 11.

The frame 11 is further provided on an outwardly projecting with a second force or torque transmission system 14 also formed by a gear ring, for transmitting a driving force or torque for the movement of the pair 3 of conveyor belts from an external drive 15 for transporting the dough piece 6 in the conveying direction. Also visible are the independently controllable first and a second external drive 13, 15, each engaging one of the transmission systems 12, 14. It is to be understood that side M and side R can rotate with respect to each other.

FIG. 5 shows the further drive train for driving the conveyor belts 3A, 3B from the pair 3 of conveyors. The gear ring 14 of the second force or torque transmission system 14 is engaged by gear wheels 17, 22, which are coupled by gear wheels 18, 22 respectively to gear wheels 19, 23, connected with driving rollers 20, 24 of conveyor belts 3A, 3B.

The rotational speed of the gear ring 14 with respect to the part of the frame 11 holding the conveyor belts 3A, 3B is proportional to the speed of the surfaces A, B for conveying dough pieces. However, the frame 11 may move with respect to external drive 15, due to movement of drive 13.

FIG. 6 shows how the speed of the second external drive 15 may be compensated for the movement of the first external drive 13.

FIG. 7 shows a dough processing device, comprising multiple devices according to the present invention, wherein multiple pairs 3 of conveyor belts share the same third conveyor belt 4 and fourth conveyor belt 1, for allowing multiple lanes of dough pieces 6 to be twisted in parallel.

The above described embodiments are examples only, and do not limit the scope of protection of the present invention, as defined in the following claims.

1: Device for twisting dough pieces, comprising:
a pair of conveyor belts, comprising a first and a second conveyor belt, with mutually facing conveying surfaces for clamping a dough piece between them, and for transporting the dough piece in the conveying direction of the mutually facing conveying surfaces of the first and a second conveyor belt, which transport direction is the longitudinal direction of said dough piece;
a third conveyor belt, positioned downstream of the pair of conveyor belts in the conveying direction, for taking over a dough piece from the pair of conveyor belts and transporting it further in the longitudinal direction thereof;
wherein
the pair of conveyor belts is rotatable around a rotation axis extending in the longitudinal direction, for twisting the dough piece around the longitudinal axis during the transfer of the dough piece from the pair of conveyor belts to the third conveyor belt.

2: Device according to claim 1, comprising a fourth conveyor belt, positioned upstream in the transport direction with respect to the pair of conveyor belts, for delivering, in the transport direction, a piece of dough to be twisted around its longitudinal axis to the pair of conveyor belts.

3: Device according to claim 1, wherein the pair of conveyor belts is suspended in a frame that is rotatable with respect to the third conveyor belt.

4: Device according to claim 3, wherein the frame is provided on an outwardly facing side with a first force or torque transmission system, such as a gear ring or a pulley for a belt, for transmitting a driving force or torque for the rotation of the frame from an external drive located outside the frame, to the frame.

5: Device according to claim 3, wherein the frame is provided on an outwardly projecting with a second force or torque transmission system, such as a gear ring or a pulley for a belt, for transmitting a driving force or torque for the movement of the pair of conveyor belts for transporting the dough piece in the conveying direction.

6: Device according to 4, provided with an independently controllable first and a second external drive, each engaging one of the transmission systems.

7: Device according to claim 1, comprising a control system, arranged for controlling the first and second external drive, in particular arranged for discounting the mutual influence of a driving force or torque for the rotation of the frame and a driving force or torque for the movement of the pair of conveyor belts.

8: Device according to claim 2, wherein the fourth conveyor belt is arranged to move continuously, and/or to continuously supply dough pieces to the conveyor belt.

9: Device according to claim 2, comprising a portioning device for supplying dough pieces to the fourth conveyor, designed for supplying dough pieces to the pair of conveyor belts with a mutual distance in the transport direction that is at least equal to the length of a dough piece.

10: Device according to claim 9, wherein the portioning device is adapted for supplying dough pieces with such a mutual distance that a number of N dough pieces together with N−1 mutual distances has a maximum length of the distance of the transport surfaces of the pair of conveyor belts facing each other.

11: Device according to claim 1, comprising a clamp for fixing the position of a downstream end of a dough piece with respect to the fourth conveyor, to prevent the dough piece from rotating during twisting.

12: Device according to claim 1, wherein the clamp is designed to move with the dough piece during twisting, and after twisting the dough piece to move back to a position for clamping a next dough piece.

13: Device according to claim 1, comprising a sensor for detecting the arrival of a dough piece or a leading end thereof, and for providing a signal indicating such arrival to a control system for rotating the pair of conveyor belts around the rotation axis.

14: Device according to claim 1, comprising multiple pairs of conveyor belts, arranged in parallel preceding a common third and/or following a common fourth conveyor belt.
